(19) United States
(12) Patent Application Publication
(10) Pub. No.: US 2015/0334137 A1
(43) Pub. Date: Nov. 19, 2015

(54) IDENTIFYING REVIEWS FROM CONTENT ASSOCIATED WITH A LOCATION

(71) Applicant: Google Inc., Mountain View, CA (US)

(72) Inventors: Sean Liu, Sunnyvale, CA (US); Andrew Theodore Wansley, San Francisco, CA (US); Rita Chen, Forest Hills, NY (US)

(21) Appl. No.: 13/898,147

(22) Filed: May 20, 2013

(51) Int. Cl. H04L 29/06

(52) U.S. Cl. CPC H04L 65/40

(57) ABSTRACT

Provided are systems, methods, and computer-readable media for identifying reviews from comments associated with a location. User-submitted comments to various services are evaluated to identify the comment as a review. If the comment is not identified as a review, no further action is taken. If the comment is identified as a review, the user is prompted for permission to publish the comment as a review of the location. If the user provides permission, the comment is stored as a review of the location.

### BACKGROUND OF THE INVENTION

1. Field of the Invention

This invention relates generally to user reviews of locations such as businesses and other points of interest, and more particularly to identifying user reviews of such locations.

2. Description of the Related Art

The Internet is useful for a variety of purposes. For example, users may use the Internet to search for entities of interest and to retrieve information, such as ratings and reviews, about businesses or other entities. Additionally, after interacting with a business or other entity, users may author reviews and provide other feedback about such entities. In some instances, the reviews may be provided on a review cite specifically provided for that purpose. However, in other instances, the reviews may be provided in comments posted on a blog, social networking service, complaint board or other website not specifically provided to receive reviews.

### SUMMARY OF THE INVENTION

Various embodiments of systems, methods, and computer-readable media for identifying reviews from comments associated with a location are provided herein. In some embodiments, a computer-implemented method is provided that includes obtaining, by one or more processors, a comment associated with a user and a location, the comment provided from at least one of: a social networking service, a microblogging service, or a blogging service and identifying, by one or more processors, the comment as a review of the location. The identifying includes determining, by one or more processors, the existence of one or more n-gram indicators in the text of the comment. The computer-implemented method further includes storing, by one or more processors, the comment as a review of the location.

Additionally, in some embodiments, non-transitory tangible computer-readable storage medium having executable computer code stored thereon for identifying reviews of a location is provided. The code includes a set of instructions that causes one or more processors to perform operations including: obtaining, by one or more processors, a comment associated with a user and a location, the comment provided from at least one of: a social networking service, a microblogging service, or a blogging service and identifying, by one or more processors, the comment as a review of the location. The identifying includes determining, by one or more processors, the existence of one or more n-gram indicators in text of the comment. The code further includes a set of instructions that causes one or more processors to perform operations that include: storing, by one or more processors, the comment as a review of the location.

In another embodiment, a system for identifying reviews of a location is provided. The system includes one or more processors and a non-transitory memory accessible by the one or more processors and having computer code stored thereon. The code includes a set of instructions that causes one or more processors to perform operations including: obtaining, by one or more processors, a comment associated with a user and a location, the comment provided from at least one of: a social networking service, a microblogging service, or a blogging service and identifying, by one or more processors, the comment as a review of the location. The identifying includes determining, by one or more processors, the existence of one or more n-gram indicators in text of the comment. The code further includes a set of instructions that causes one or more processors to perform operations including: storing, by one or more processors, the comment as a review of the location.

### BRIEF DESCRIPTION OF THE DRAWINGS

FIG. 1 is a block diagram illustrating identification of reviews from location-tagged comments authored by a user in accordance with an embodiment of the present invention;

FIG. 2 is a block diagram of a process for identifying a location-tagged comment authored by a user as a review of a location in accordance with an embodiment of the present invention;

FIG. 3 is a block diagram of another process for identifying a location-tagged comment authored by a user as a review of a location in accordance with an embodiment of the present invention;

FIG. 4 is a block diagram of a system for identifying location-tagged content authored by a user as a review of a location in accordance with an embodiment of the present invention;

FIG. 5 is a block diagram of a computer in accordance with an embodiment of the present invention.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems, methods, and computer-readable media for identifying reviews from comments associated with a location. A user visiting a location may submit a location-tagged comment to a social networking service, a microblog, a blog, or other such services or webpages. For example, after the user leaves the location, the user may submit a comment to a social networking cite that describes the user's experience at the location. The submitted comment may be evaluated to determine whether the content is a review. For example, as described below, the comment may be evaluated using a support vector machine using n-gram indicators to determine whether the comment is a review. As used herein, a location tagged comment refers to a comment made about a particular location, an entity at the particular location, or a comment made while situated at the particular location or an entity at the particular location.

If the comment is not identified as a review, no further action is taken. If the comment is identified as a review, then the user is prompted for permission to publish the content as a review of the location. If the user does not provide permission, the comment is not published as a review. If the user provides permission to publish the comment as a review, the user is prompted to select all or portions of the comment for publishing. The comment (or selected portions) is then stored as a review of the location. In some embodiments, all previous location-tagged comments from a user are processed. Additionally, in some embodiments, a user is prompted to tag the comment as a review upon submission of the comment.

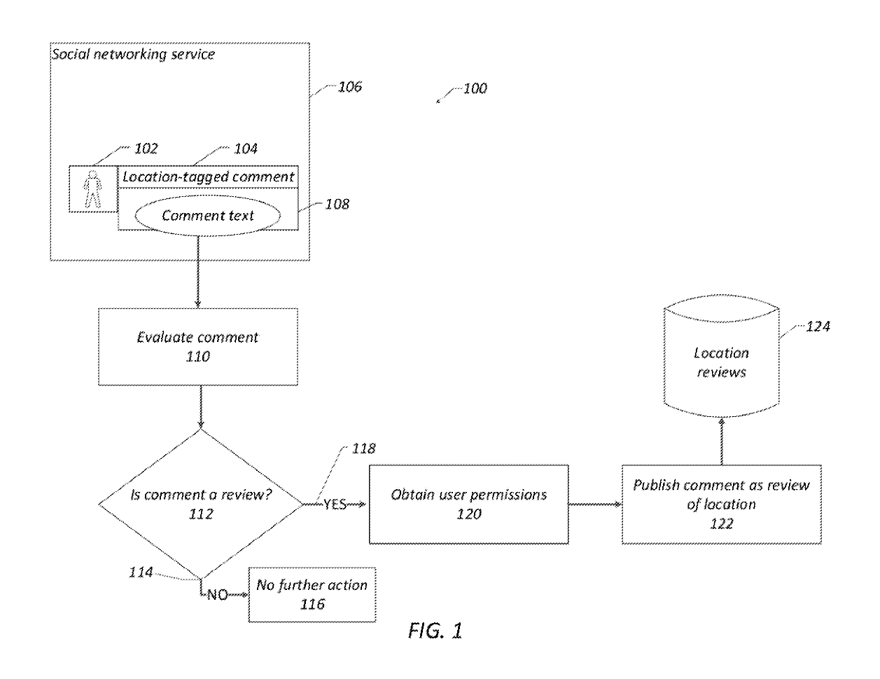

FIG. 1 is a block diagram of a process 100 for identifying user reviews from user-authored comments associated with a location in accordance with an embodiment of the present invention. As shown in FIG. 100, a user 100 writes a location-tagged comment 104, and posts the location-tagged comment 104 on a social networking service 106. Although the comment 104 is not explicitly identified as a review, a location tagged to the comment 104 indicates the comment is related to the location and may be a review of an entity at the location. The comment includes comment text 108 authored by the user 102 that may describe the user's experiences interacting with the entity at the location, the performance of the entity, the user's satisfaction with the entity, and so on.

Next, the comment 104 posted to the social networking service 106 is evaluated to determine whether it contains a review (block 110). As described further below, in some embodiments the evaluation includes processing the comment using an n-gram based support vector machine. The evaluation includes determining if the comment is a review of an entity at the location (decision block 112). If the comment is not determined to be a review (line 114), no further action is taken (block 116). If the comment is determined to be a review (line 118), then permission to publish the comment is obtained from the user (block 120). If the user provides permission, the comment is published as a review of the entity at the location (block 122). For example, the comment 104 and an associated location or entity identifier may be stored in a database 124 of location reviews. In some embodiments, the published comment is then made available on a webpage identifying the location or entity and providing information about the location or entity (e.g., a “place page”), websites that provide reviews of locations or entities, and the like.

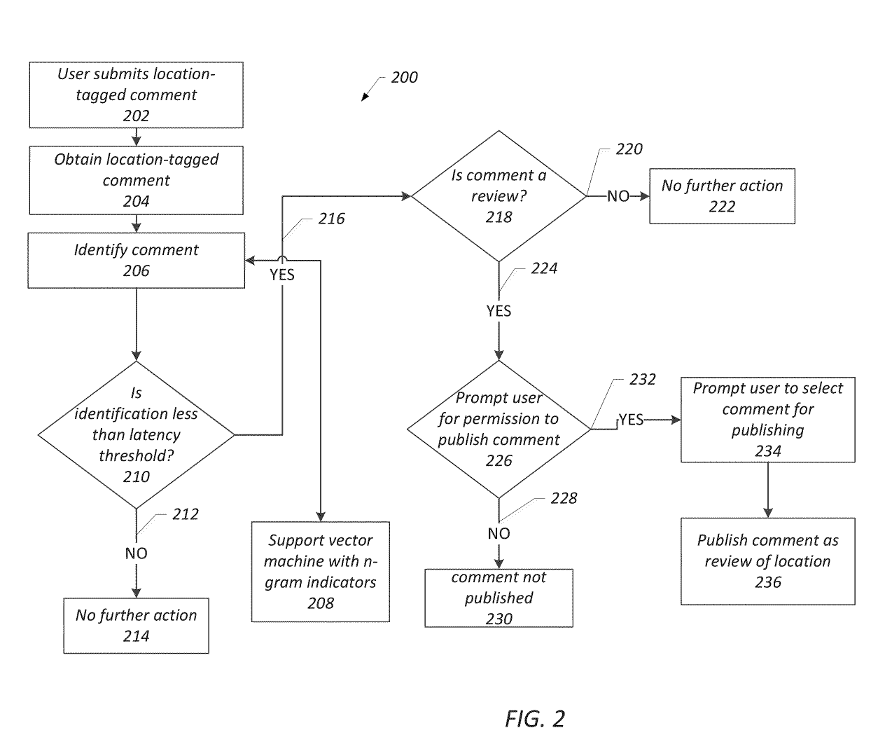

FIG. 2 depicts a process 200 for identifying a location-tagged comment submitted by a user as a review of an entity at the location in accordance with an embodiment of the present invention. Initially, a user submits a location-tagged comment (block 202), such as by submitting the comment to a social networking service, a blog, or other services or websites. As noted above, the location-tagged comment is not identified as a review, but the location-tagged comment may include a description of a user's experience at an entity at the location, a user's opinion of the entity, and so on. Next, the location-tagged comment is obtained (block 204). For example, a user may explicitly submit the location-tagged comment for identification, or the location-tagged comment may be automatically extracted from the service on which it was posted (e.g., from a webpage provided by a social networking service, a blogging service, a microblogging service, and the like).

Next, the comment is evaluated to identify whether the comment is a review of the location or an entity at the location (block 206). In some embodiments the evaluation includes processing the comment using an n-gram based support vector machine 208. In such embodiments, the support vector machine is trained on a corpus of explicit reviews and location-tagged comments. The corpus of reviews and location-tagged comments are obtained from previously submitted reviews of a location and comments that are tagged with the location. The location-tagged comments are manually processed to identify comments that are and that are not reviews. Based on this corpus of explicit reviews and manually identified location-tagged comments that are and are not reviews, a support vector machine is trained using word-based n-grams is trained to identify reviews in location tagged comments. The support vector machine may then be used to identify reviews from location-tagged comments that are not part of the training set using the n-gram indicators. For example, the support vector machine can be trained to identify location-tagged comments containing the n-grams “reasonably priced entrees” and “service was excellent” to be restaurant reviews.

In some embodiments, the execution time of the evaluation is compared to a latency threshold (decision block 210). If the execution time of the evaluation is greater than the latency threshold (line 212), no further action is taken (block 214). If the execution time is less than or equal to the latency threshold (line 216), then a decision is reached indicating whether the comment is a review (decision block 218). If the comment is not identified as a review (line 220), then no further action is taken (block 222). If the comment is identified as a review (line 224), then the user is prompted for permission to publish to the comment (decision block 226). If the user does not provide permission to publish the comment (line 228), then the comment is not published (block 230). If the user provides permission to publish the comment (line 232) then, in some embodiments, the user is prompted to select the portions of the comment for publishing (block 234). For example, the user may select the entire comment for publishing or may select only portions of the comment for publishing. Next, the comment is published as a review of the location associated with the comment or an entity at that location (block 236). For example, as described above, in some embodiments the comment is associated with an identifier for the location or entity, and is stored in a database or other data structure indexed by the location or entity identifier. The comment may be provided as a review of the location or entity in response to subsequent requests for reviews of the location or entity, such as in response to a selection of a search result.

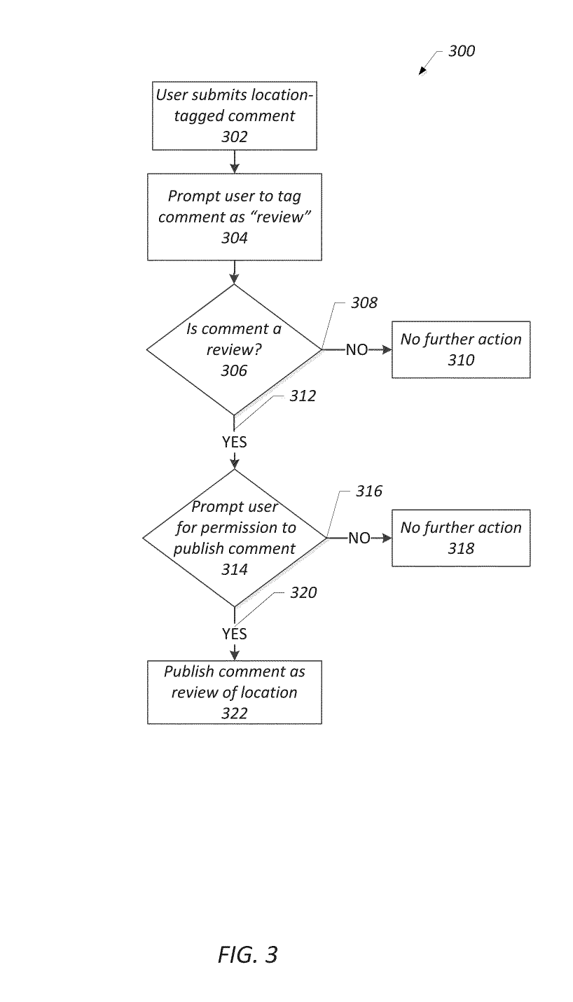

In some embodiments, a user is provided with the option to manually identify a location-tagged comment as a review. FIG. 3 depicts a process 300 for identifying a location-tagged comment submitted by a user as a review of a location or entity in accordance with an embodiment of the present invention. Initially, a user submits a location-tagged comment (block 302), such as by submitting the comment to a social networking service, a blog, or other services. As noted above, the location-tagged comment is not identified as a review of the location, but the location-tagged comment may include a description of a user's experience at the location, a user's opinion of the location, and so on. Next the user is prompted to identify the comment as a review (block 304). In some embodiments, a prompt is provided in response to all location-tagged comments submitted by a user. In other embodiments, a prompt is provided based on an evaluation of the location-tagged comment identifying the comment as a review. For example, the evaluation may include an identification of keywords or more detailed processing, such as the support vector machine processing described above.

Further processing is based on whether the location-tagged comment has been identified as a review (decision block 306). If the comment is not a review (line 308), then no further action is taken (block 310). If the comment is a review (line 312), then the user is prompted for permission to publish the comment (decision block 314). If the user does not provide permission to publish the comment (line 316), then no further action is taken (block 318). If the user provides permission to publish the comment (line 320) then the comment is published as a review of the location or an entity at the location (block 322). Additionally, in some embodiments, the user is prompted to select all or portions of the comment for publishing as the review. As described above, the comment may be associated with an identifier for the location or entity and stored in a database or other data structure and provided in response to requests for reviews.

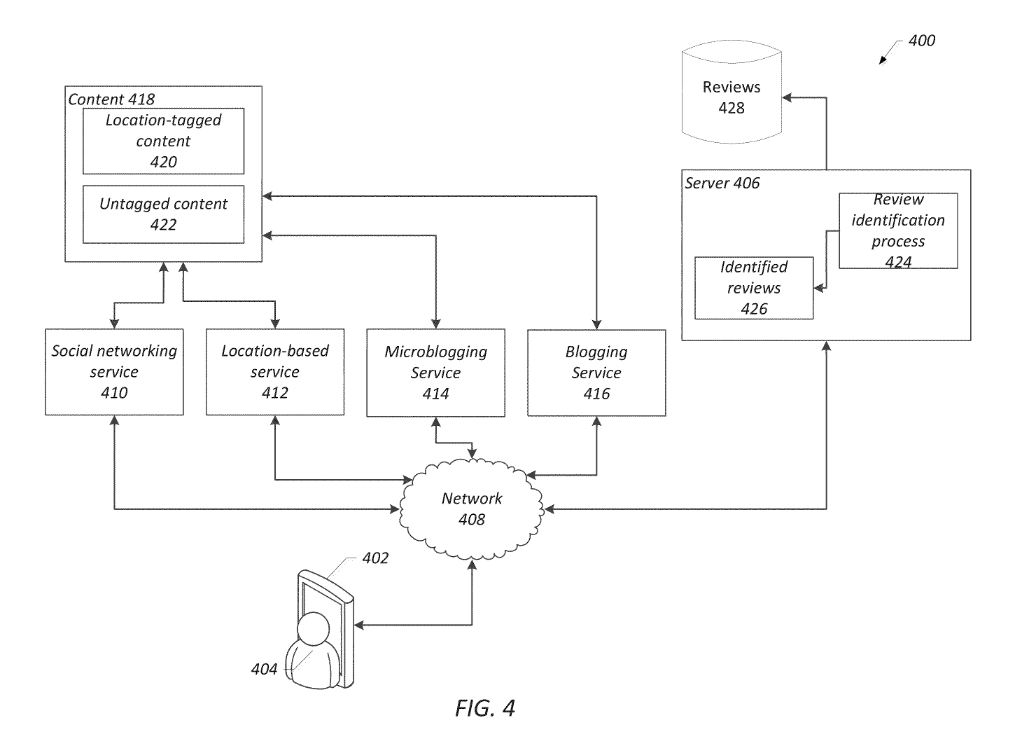

FIG. 4 depicts a system 400 for identifying location-tagged comments authored by a user as a review of a location or entity in accordance with an embodiment of the present invention. The system includes a client computer 402 for a user 404 and a server 406 (e.g., one or more servers) in communication via a network 408. Additionally, various web services are in communication with the network 408 and accessible by the client 402. For example, the web services may include a social networking service 410, a location-based service 412, a microblogging service 414, and a blogging service 416. As will be appreciated, each service may include or be described as a website and may provide webpages for viewing and interaction by users. Each service may be hosted or provided by one or more servers. The one or more servers may or may not be coextensive with the one or more servers 406 providing the location-tagged comment review identification process 424. The client computer 402 may include laptop computers, tablet computers, smartphones, personal digital assistants, etc., and may include a receiver for a satellite-based positioning system, such as a Global Positioning System (GPS) receiver. In some embodiments, the client computer 402 may include a desktop computer. A user may use the client computer 402 to retrieve information, view interactive maps, perform computer-implemented searches, and author and submit comments to the web services described above.

The server 406 may be a single server (in a discrete hardware component or as a virtual server) or multiple servers. The server 406 may include web servers, application servers, or other types of servers. Additionally, the server 406 may be, for example, computers arranged in any physical and virtual configuration, such as computers in one or more data processing centers, a distributed computing environment, or other configuration. Such configurations may use the network 408 for communication or may communicate over other networks.

The client computer 402 and server 406 are in communication with the network 408, such as through a wired or wireless network interface. In some embodiments, the network 408 may include multiple networks, and may include any suitable network and networking technology, such as the Internet, an intranet, a local area network (LAN), a wide area network (WAN), or any other suitable network. Additionally, the network 208 may include a wired network, a wireless network, or both. Moreover, it should be appreciated that the client computer 402 and server 406 may communicate over different networks separately and simultaneously. For example, the client computer 402 may communicate over both a wireless Ethernet network and a cellular network

The social networking service 410 may provide a social graph associated with the user 404 and enable the user to communicate with persons included in the social graph, persons excluded from the social graph, and entities having a presence on the social networking service 410. In some embodiments, the social graph is automatically generated by the social networking service 410 or manually created by the user 404, and the user may add or remove persons to and from the social graph. Content submitted to the social networking service 410 may be provided on a webpage associated with the user, a webpage associated with a person in the user's social graph, or a webpage associated with a location. For example, in some embodiments a location-tagged comment may be provided on one or more such webpages for viewing by the user, persons in the user's social graph, or other users of the social networking service 410. User permission may be required to post the user's content, e.g., to persons outside of the user's social network, and the user may generally be given controls to indicate where the user's content can be posted, and how it can be disseminated to people in and outside of the user's social graph.

The location-based service 412 may allow a user to submit the user's location for various purposes, e.g., for viewing by persons in a social graph associated with the user or to receive advertisements or coupons from vendors at or near the location. For example, a user may “check-in” or “check-out” at a location to indicate the user's presence at the location. In some embodiments, the location-based service 412 may automatically indicate the user's presence at a location based on the position determined by and obtained from the client computer 402. In some embodiments, user permission is required prior to obtaining or posting information regarding the user's location. Additionally, in some embodiments the user 404 may view the location of persons in the user's social graph who have provided permission to share their location with the user 404. Additionally, the location-based service 412 may receive content from the user 404. For example, after “checking-in” to a location, the user 404 may submit a location-tagged comment that is tagged with the location based on the user's “check-in.” The comments may be published with user permission, and viewed by other users, such as persons from the social graph associated with user 404, when viewing information about the location.

The microblogging service 414 may receive content, e.g., microblogs, from the user 404. In some embodiments, the microblogs submitted by the user 404 are automatically tagged with a location determined by and obtained from the client computer 402. In other embodiments, the user 404 may tag the microblog with a location during submission. In some embodiments, the microblog may be distinguished from other content by limitations on the size of the comment. For example, the microblog may be limited to a number of characters or a memory size. The microblogs submitted by the user 404 may be provided on a webpage associated with the user 404 and viewed by other users of the microblogging service 414. Such microblogs may be public and viewable by any users of the microblogging service 414 or such microblogs may be private and only viewable by other users having an identified relationship to the user 404. The blog postings submitted by the user 404 may be automatically tagged with a location determined by and obtained from the client computer 402 or the user 404 may tag the microblog with a location during submission. User permission may be required to tag the microblog with the user's location.

The blogging service 416 may receive location-tagged comments (“blog posts”) from the user 404. The blogging service 416 may receive such comments for posting to a blog, e.g., a webpage that aggregates and displays a user's submitted comments for viewing on the Internet. In such embodiments, the blog may be public and viewable by any users of the Internet, or the blog may be private and only viewable by other users having an identified relationship to the user 404. Here again, the blog posts submitted by the user 404 may be automatically tagged with a location determined by and obtained from the client computer 402, or, in some embodiments, the user 404 may tag the blog post with a location during submission. User permission may be required to tag the blog post with the user's location, and/or to share the blog post with other users.

The user 404 uses the client computer 402 to author content and submit content 418 to the various web services via the network 408. For example, the user 404 may visit a location (e.g., a restaurant, bar, and the like) and submit content to the social networking service 410 that describes the user's experience at the location or an entity at the location. In another example, a user may submit a microblog (a “tweet”) during or after the user's visit to the location. In yet another example, the user may author a blog comment and submit the comment to the user's blog (or another blog) via the blogging service 416. In some embodiments, the location tagged to submitted content is generated from a determined position of the client computer 402. For example, the client computer 402 may determine its own position via GPS signals, or may have its position determined (e.g., via servers associated with the location-based service 412) via triangulation from Wi-Fi access point or cell tower connections, and that position may be associated with an entity at that location. As will be appreciated, the content 418 authored and submitted by the user 404 may include both location-tagged content 420 and untagged content 422. The untagged content 422 is not tagged with a location and is not processed by the server 406.

The server 406 includes a review identification process 424 that obtains location-tagged content 420 and processes the content in accordance with the techniques described herein. As described above, the review identification process 424 identifies reviews 426 of locations from the location-tagged content 420. In some embodiments, location-tagged content 420 can be identified as a review based on an n-gram analysis of the content by a support vector machine as described above. The identified reviews 426 may associated with a location identifier and stored in a database 428 or other data structure stored on or accessible by the server 406.

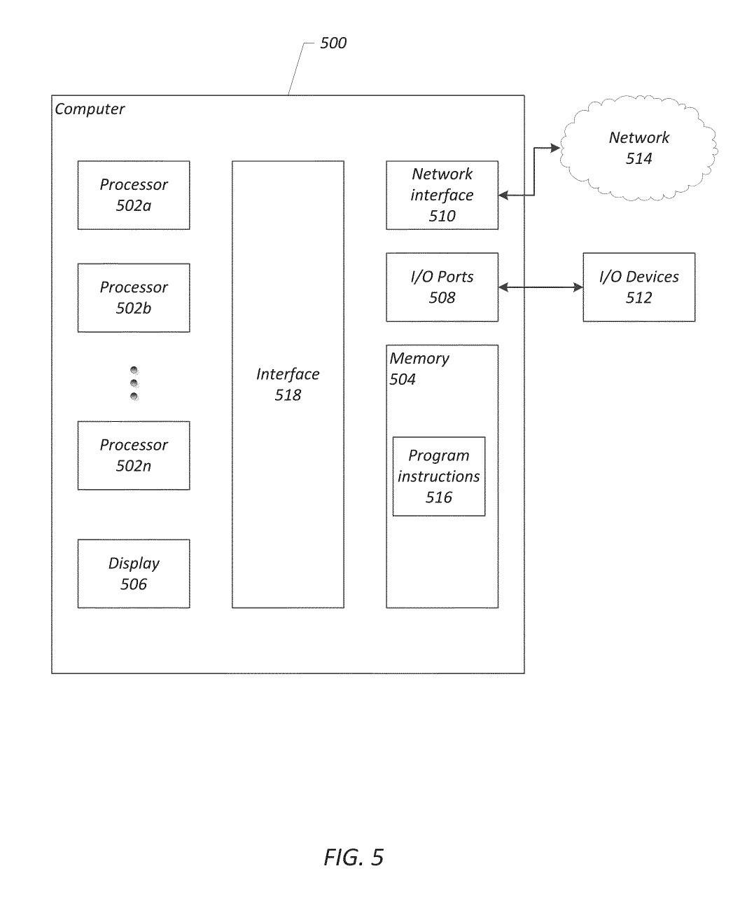

FIG. 5 depicts a computer 500 in accordance with an embodiment of the present invention. Various portions or sections of systems and methods described herein include or are executed on one or more computers similar to computer 500 and programmed as special-purpose machines executing some or all steps of methods described above as executable computer code. Further, processes and modules described herein may be executed by one or more processing systems similar to that of computer 500.

The computer 500 may include various internal and external components that contribute to the function of the device and which may allow the computer 500 to function in accordance with the techniques discussed herein. As will be appreciated, various components of computer 500 may be provided as internal or integral components of the computer 500 or may be provided as external or connectable components. It should further be noted that FIG. 5 depicts merely one example of a particular implementation and is intended to illustrate the types of components and functionalities that may be present in computer 500.

Computer 500 may include any combination of devices or software that may perform or otherwise provide for the performance of the techniques described herein. For example, computer 500 may include or be a combination of a cloud-computing system, a data center, a server rack or other server enclosure, a server, a virtual server, a desktop computer, a laptop computer, a tablet computer, a mobile telephone, a personal digital assistant (PDA), a media player, a game console, a vehicle-mounted computer, or the like. The computer 500 may be a unified device providing any one of or a combination of the functionality of a media player, a cellular phone, a personal data organizer, a game console, and so forth. Computer 500 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

In addition, the computer 500 may allow a user to connect to and communicate through a network 514 (e.g., the Internet, a local area network, a wide area network, etc.) and to acquire data from a satellite-based positioning system (e.g., GPS). For example, the computer 500 may allow a user to communicate using e-mail, text messaging, instant messaging, or using other forms of electronic communication, and may allow a user to obtain the location of the device from a satellite-based positioning system, such as the location on an interactive geographic map. As shown in FIG. 5, the computer 500 may include one or more processors (e.g., processors 502a-502n) coupled to a memory 504, a display 506, I/O ports 508 and a network interface 510, via an interface 518.

In one embodiment, the display 506 may include a liquid crystal display (LCD) or an organic light emitting diode (OLED) display, although other display technologies may be used in other embodiments. The display 506 may display a user interface (e.g., a graphical user interface). The display 506 may also display various function and system indicators to provide feedback to a user, such as power status, call status, memory status, etc. These indicators may be in incorporated into the user interface displayed on the display 506. In accordance with some embodiments, the display 506 may include or be provided in conjunction with touch sensitive elements through which a user may interact with the user interface. Such a touch-sensitive display may be referred to as a “touch screen” and may also be known as or called a touch-sensitive display system.

The processor 502 may provide the processing capability required to execute the operating system, programs, user interface, and any functions of the computer 500. The processor 502 may include one or more processors and include “general-purpose” microprocessors and special purpose microprocessors, such as ASICs. For example, the processor 502 may include one or more reduced instruction set (RISC) processors, such as those implementing the Advanced RISC Machine (ARM) instruction set. Additionally, the processor 502 may include single-core processors and multicore processors and may include graphics processors, video processors, and related chip sets. A processor may receive instructions and data from a memory (e.g., system memory 504). Accordingly, computer 500 may be a uni-processor system including one processor (e.g., processor 502a), or a multi-processor system including any number of suitable processors (e.g., 502a-502n). Multiple processors may be employed to provide for parallel or sequential execution of one or more sections of the techniques described herein. Processes, such as logic flows, described herein may be performed by one or more programmable processors executing one or more computer programs to perform functions by operating on input data and generating corresponding output.

The memory 504 (which may include one or more tangible non-transitory computer readable storage medium) may include volatile memory and non-volatile memory accessible by the processor 502 and other components of the computer 500. The memory 504 may store a variety of information and may be used for a variety of purposes. For example, the memory 504 may store executable computer code, such as the firmware for the computer 500, an operating system for the computer 500, and any other programs or other executable code necessary for the computer 500 to function. The executable computer code may include program instructions 516 executable by a processor (e.g., one or more of processors 502a-502n) to implement one or more embodiments of the present invention, such as processes 200 and 300 described above. Instructions 516 may include modules of computer program instructions for implementing one or more techniques described herein with regard to various processing modules. Program instructions 516 may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, a subroutine. A computer program may or may not correspond to a file in a file system. A program may be stored in a section of a file that holds other programs or data (e.g., one or more scripts stored in a markup language document), in a single file dedicated to the program in question, or in multiple coordinated files (e.g., files that store one or more modules, sub programs, or sections of code). A computer program may be deployed to be executed on one or more computer processors located locally at one site or distributed across multiple remote sites and interconnected by a communication network. In addition, the memory 504 may be used for buffering or caching during operation of the computer 500.

As mentioned above, the memory 504 may include volatile memory, such as random access memory (RAM). The memory 504 may also include non-volatile memory, such as ROM, flash memory, a hard drive, any other suitable optical, magnetic, or solid-state storage medium, or a combination thereof. The memory 504 may store data files such as media (e.g., music and video files), software (e.g., for implementing functions on computer 500), preference information (e.g., media playback preferences), transaction information (e.g., information such as credit card information), wireless connection information (e.g., information that may enable media device to establish a wireless connection such as a telephone connection), telephone information (e.g., telephone numbers), and any other suitable data.

The interface 518 may include multiple interfaces and may couple various components of the computer 500 to the processor 502 and memory 504. In some embodiments, the interface 518, the processor 502, memory 504, and one or more other components of the computer 500 may be implemented on a single chip, such as a system-on-a-chip (SOC). In other embodiments, these components, their functionalities, or both may be implemented on separate chips. The interface 518 may be configured to coordinate I/O traffic between processors 502a-502n, system memory 504, network interface 510, I/O devices 512, other peripheral devices, or a combination thereof. The interface 518 may perform protocol, timing or other data transformations to convert data signals from one component (e.g., system memory 504) into a format suitable for use by another component (e.g., processors 502a-502n). The interface 518 may include support for devices attached through various types of peripheral buses, such as a variant of the Peripheral Component Interconnect (PCI) bus standard or the Universal Serial Bus (USB) standard.

The computer 500 may also include an input and output port 508 to allow connection of additional devices, such as I/O devices 512. Embodiments of the present invention may include any number of input and output ports 508, including headphone and headset jacks, universal serial bus (USB) ports, Firewire or IEEE-1394 ports, and AC and DC power connectors. Further, the computer 500 may use the input and output ports to connect to and send or receive data with any other device, such as other portable computers, personal computers, printers, etc.

The computer 500 depicted in FIG. 5 also includes a network interface 510, such as a wired network interface card (NIC), wireless (e.g., radio frequency) interface cards, etc. For example, the network interface 510 may receive and send electromagnetic signals and communicate with communications networks and other communications devices via the electromagnetic signals. The network interface 510 may include known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The network interface 510 may communicate with networks (e.g., network 514), such as the Internet, an intranet, a cellular telephone network, a wireless local area network (LAN), a metropolitan area network (MAN), or other devices by wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11a, IEEE 802.11b, IEEE 802.11g or IEEE 802.11n), voice over Internet Protocol (VoIP), Wi-MAX, a protocol for email (e.g., Internet message access protocol (IMAP) or post office protocol (POP)), messaging (e.g., extensible messaging and presence protocol (XMPP), Session Initiation Protocol for Instant Messaging and Presence Leveraging Extensions (SIMPLE), Instant Messaging and Presence Service (IMPS)), Multimedia Messaging Service (MMS), Short Message Service (SMS), or any other suitable communication protocol.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

1. A computer-implemented method for identifying reviews of a location, the method comprising:
obtaining, by at least some of one or more processors, a user comment
associated with a geolocation, the user comment provided from at least one of: a social networking service, a microblogging service, or a blogging service, wherein the user comment, as obtained, is not labeled as containing a review;
classifying, by at least some of the one or more processors, the user comment as including a review of an entity associated with the geolocation, based on the existence of one or more n-gram indicators in a text of the user comment, including using a support vector machine trained with previously submitted comments processed to identify comments that are and that are not reviews; and
in response to classifying the user comment as including a review, storing, by at least some of the one or more processors, at least part of the user comment as a review of the entity associated with the geolocation, the storing creating a record that indicates the at least part of the user comment is a review and associates the at least part of the user comment with the geolocation or the entity.

2. The computer-implemented method of claim 1, further comprising transmitting the review over a network to a client computer in response to a request for reviews of the entity, wherein:
obtaining the user comment comprises automatically extracting the user comment from a service upon which the user comment was posted by the user;
classifying the user comment as including a review comprises classifying, with the support vector machine, part of the user comment as including the review and classifying another part of the user comment as not including the review;
storing at least part of the user comment as a review comprises indexing, by an identifier of the entity, the part of the comment classified as a review in a review index.

3. The computer-implemented method of claim 1, wherein classifying the user comment as including a review comprises classifying part of the user comment as including the review and classifying another part of the user comment as not including the review.

4. (canceled)

5. The computer-implemented method of claim 1, further comprising obtaining, in response to classifying the user comment as including the review, permission from the user to publish at least part of the user comment as a review of the entity by sending a prompt to select portions of the comment to be published as the review.

6. The computer-implemented method of claim 1, wherein the entity comprises at least one of: a restaurant, a bar or a retail store.

7. The computer-implemented method of claim 1, wherein classifying the user comment as including the review comprises comparing an execution duration of the classification to a latency threshold and classifying the user comment as including the review in response to the execution duration satisfying the latency threshold.

8. A non-transitory tangible computer-readable storage medium having executable computer code stored thereon for identifying reviews of a location, the code
comprising a set of instructions that causes one or more processors to perform operations comprising:
obtaining, by at least some of one or more processors, a user comment associated with a geolocation, the user comment provided from at least one of: a social networking service, a microblogging service, or a blogging service, wherein the user comment, as obtained, is not labeled as containing a review;
classifying, by at least some of the one or more processors, the user comment as including a review of an entity associated with the geolocation, based on the existence of one or more n-gram indicators in a text of the user comment, including using a corpus of previously submitted comments processed to identify comments that are and that are not reviews; and
in response to classifying the user comment as including a review, storing, by at least some of the one or more processors, at least part of the user comment as a review of the entity associated with the geolocation, the storing creating a record that indicates the at least part of the user comment is a review and associates the at least part of the user comment with the geolocation or the entity.

9. The non-transitory tangible computer-readable storage medium of claim 8, wherein the code further comprises a set of instructions that causes one or more processors to perform operations comprising:
transmitting the review over a network, by one or more processors, to a client computer in response to a request for reviews of the entity, wherein:
obtaining the user comment comprises automatically extracting the user comment from a service upon which the user comment was posted by the user;
classifying the user comment as including a review comprises classifying, with a previously trained support vector machine, part of the user comment as including the review and classifying another part of the user comment as not including the review;
the previously trained support vector machine is trained on a corpus of comments including other user comments explicitly labeled as reviews by users submitting the other user comments; and
storing at least part of the user comment as a review comprises indexing, by an identifier of the entity, the part of the comment classified as a review in a review index, the storing creating a record that indicates the at least part of the user comment is a review and associates the at least part of the user comment with the geolocation or the entity.

10. The non-transitory tangible computer-readable storage medium of claim 8, wherein classifying the user comment as including a review comprises classifying part of the user comment as including the review and classifying another part of the user comment as not including the review.

11. The non-transitory tangible computer-readable storage medium of claim 10, wherein classifying, by one or more processors, the user comment as including the review comprises classifying the user comment using a support vector machine trained to identify user comments as reviews based on the one or more n-gram indicators.

12. The non-transitory tangible computer-readable storage medium of claim 8, wherein the code further comprises a set of instructions that causes one or more processors to perform operations comprising: obtaining, in response to classifying the user comment as including the review, permission from the user to publish at least part of the user comment as a review of the entity by sending a prompt to select portions of the comment to be published as the review.

13. The non-transitory tangible computer-readable storage medium of claim 8, wherein the entity comprises at least one of: a restaurant, a bar or a retail store.

14. The non-transitory tangible computer-readable storage medium of claim 8, wherein classifying the user comment as a including the review, comprises comparing an execution duration of the classification to a latency threshold and classifying the user comment as including the review in response to the execution duration satisfying the latency threshold.

15. A system for identifying user reviews of a geolocation, the system comprising:
one or more processors; and
non-transitory memory accessible by the one or more processors, the memory having computer code stored thereon, the code comprising a set of instructions that causes the one or more processors to perform operations comprising:
obtaining a user comment associated with a geolocation, the user comment provided from at least one of: a social networking service, a microblogging service, or a blogging service, wherein the user comment, as obtained, is not labeled as containing a review;
classifying the user comment as including a review of an entity associated with the geolocation, based on the existence of one or more n-gram indicators in a text of the user comment, including using a corpus of previously submitted comments processed to identify comments that are and that are not reviews; and
in response to classifying the user comment as including a review, storing, at least part of the user comment as a review of the entity associated with the geolocation, the storing creating a record that indicates the at least part of the user comment is a review and associates the at least part of the user comment with the geolocation or the entity.

16. The system of claim 15, wherein the code further comprises a set of
instructions that causes one or more processors to perform operations comprising: transmitting the review over a network to a client computer in response to a request for reviews of the entity, wherein:
obtaining the user comment comprises automatically extracting the user comment from a service upon which the user comment was posted by the user;
classifying the user comment as including a review comprises classifying, with a previously trained support vector machine, part of the user comment as including the review and classifying another part of the user comment as not including the review;
the previously trained support vector machine is trained on the corpus of comments including other user comments explicitly labeled as reviews by users submitting the other user comments; and
storing at least part of the user comment as a review comprises indexing, by an identifier of the entity, the part of the comment classified as a review in a review index, the storing creating a record that indicates the at least part of the user comment is a review and associates the at least part of the user comment with the geolocation or the entity location.

17. The system of claim 15, wherein classifying the user comment as including a review comprises classifying part of the user comment as including the review and classifying another part of the user comment as not including the review.

18. The system of claim 17, wherein classifying the user comment as the review comprises using a support vector machine trained to identify user comments as reviews based on the one or more n-gram indicators.

19. The system of claim 15, wherein the code further comprises a set of instructions that causes one or more processors to perform operations comprising: obtaining, in response to classifying the user comment as including the review, permission from the user to publish at least part of the user comment as a review of the entity by sending a prompt to select portions of the comment to be published as the review.

20. The system of claim 15, wherein the location entity comprises at least one of: a restaurant, a bar or a retail store.

21. The system of claim 15, wherein classifying the user comment as a including the review, comprises comparing an execution duration of the classification to a latency threshold and classifying the user comment as including the review in response to the execution duration satisfying the latency threshold.

22. The computer-implemented method of claim 1, further comprising training the support vector machine using manually identified location-based comments.
